(19) United States
(12) Patent Application Publication
(10) Pub. No.: US 2008/0028380 A1
(43) Pub. Date: Jan. 31, 2008

(54) Localized, incremental single static assignment update

(76) Inventors: Liang Guo, San Jose, CA (US); Swaroop V. Dutta, San Jose, CA (US); Andrew R. Trick, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/494,142

(22) Filed: Jul. 26, 2006

(51) Int. Cl. G06F 9/45

(52) U.S. Cl. 717/151

(57) ABSTRACT

A computer-implemented method for performing code optimization on source code is provided. The computer-implemented method includes generating a first control flow graph and a first single static assignment graph from the source code. The computer-implemented method also includes generating a first dominator tree from the first flow control graph. The computer-implemented method further includes performing at least one of single static assignment-based high level optimization and code transformation utilizing at least one of the first flow control graph and the first single static assignment graph. The computer-implemented method moreover includes generating a second flow control graph responsive to the performing the code transformation. The computer-implemented method yet also includes generating a second single static assignment graph utilizing the second flow control graph and the first dominator tree. The computer-implemented method yet further includes generating optimized code utilizing the second flow control graph and the second single static assignment graph.

### BACKGROUND OF THE INVENTION

In the computer field, compiling, which is the process of converting a computer program from a high-level programming language (e.g., C++, Java, C, Visual Basic, etc.) into a low-level language (e.g., assembly language, machine language, etc.) that may be executable by a central processing unit (CPU), can be an expensive and time-consuming process. To provide a high quality executable code, the compiler may have to perform code optimization on the computer program. In recent years, performing code optimization on a computer program in a single static assignment (SSA) form has gained popularity as this approach has resulted in more efficient and effective optimization.

As discussed herein, a SSA graph refers to a form of intermediate representation (i.e., graphical data structure of the portion of the computer program being compiled) in which each variable in a computer program that is being compiled is assigned (e.g., defined) once. If a variable occurs more than once, then a unique designation may be assigned to each variable to distinguish between the different versions of the variables.

To facilitate discussions, FIG. 1 shows a simple control flow graph (CFG) in a SSA form. As discussed herein, a CFG refers to a form of an intermediate representation in which the possible paths that a computer program may traverse is illustrated as basic blocks (i.e., sequence of instructions) interconnected by direct edges (i.e., arrows). Generally, source code is converted into a CFG for data flow analysis and code optimization. Basic blocks 132-138 show a source code 100 graphically in CFG format. However, as can be seen, each of the definitions of variables has not been distinguished from one another. Since CFG graph 150 have multiple instances of the variable ‘x’, SSA form may have to be employed to simplify the process of distinguishing each definition of variable

A CFG graph in SSA form 160 shows a plurality of basic blocks (102-108). In a basic block 102, the first instance of variable ‘x’ (i.e., ‘x<0 of a basic block 132) is shown as ‘x₁<0. At a basic block 104, the second instance of variable ‘x’ (i.e., ‘x=0 of a basic block 134) is defined as ‘x₂=0. At a basic block 106, another instance of variable ‘x’ (i.e., ‘x=x*2) of a basic block 136) is defined. However, at basic block 106 a merge point has occurred and the value of ‘x’ can flow from either basic block 102 (path 158) or basic block 104 (path 160); thus, a phi instruction (e.g., ‘x₃=φ(x₁, x₂)’) may have to be created to account for these possibilities. As discussed herein, a phi instruction refers to a special instruction that may be added at a merge point to identify the possible variables that may be employed to determine a value. With a phi instruction inserted, the equation ‘x=x*2 of basic block 136 may now be shown as ‘x₄=x₃*2 in basic block 106. Finally, at a basic block 108, the value of variable ‘x’ is returned. No new designation for variable ‘x’ is needed, since basic block 108 is simply returning a value for a variable identified in basic block 106.

With the source code in SSA form, variables are easily identified and defined; thus, the compiler may perform data flow analysis and code optimization more efficiently and effectively. As the compiler performs the various code optimization techniques, the SSA graph may be updated. In one example, some code optimization techniques (e.g., global value numbering, conditional constant propagation, front-end loop optimization, etc.) may reduce redundant code and/or remove dead code (i.e., code that is never executed), resulting in variables being removed. In another example, other code optimization techniques (i.e., code transformations) may create new code instructions, resulting in new variables being added.

As discussed herein, code transformation refers to a technique of optimizing the source code by cloning a region of basic blocks (i.e., sequence of instructions) of a CFG. Generally, the region that may be cloned may include a loop and/or require a set of instructions prior to a merge point to be completed before the rest of the instructions may be performed. Transformations may include, but is not limited to, loop unrolling and tail duplication.

Since code transformations generally result in additional basic blocks, a new CFG may have been generated. In addition, new basic blocks generally indicate that new definitions of variables may have been generated, thus, the SSA graph may have to be updated to reflect the new variables that may have been cloned. FIG. 2 shows a simple flow chart diagramming the steps for updating a SSA graph.

At a first step 202, the compiler may identify a new dominator tree by performing a global CFG analysis (i.e., analyzing the complete module, with the new basic blocks, that is being compiled). As discussed herein, a dominator tree refers to a data structure that provides a relationship between the various basic blocks by identifying the dominators and the child nodes. As discussed herein, a dominator refers to a basic block that dominates another basic block, in the sense that all control flow paths that reach the dominated basic block must first pass through the dominating basic block. A block's immediate dominator dominates the block without dominating any other dominators of the same block. In the dominator tree, each block constitutes a child node of its immediate dominator. Referring back to FIG. 1, basic block 102 is an immediate dominator of basic block 106. In other words, to reach basic block 106, the compiler must always traverse through basic block 102.

At a next step 204, the compiler may compute a set of iterative dominator frontier (IDF) basic blocks by analyzing the new CFG and by analyzing the new dominator tree. As discussed herein, an IDF basic block refers to a basic block that may be reached from more than one path. Referring back to FIG. 1, basic block 106 is an example of an IDF basic block since the compiler can traverse through either basic block 102 or basic block 104 to reach the same destination. Once a set of IDF has been identified, new phi instructions may be created and inserted into each of the IDF basic blocks. Hence, a set of IDF basic blocks may also refer to a set of basic blocks at which phi instructions may be inserted. Inserting new phi instructions into the IDF basic blocks for the new CFG can become a time-consuming and expensive process, especially if only a small region of a large CFG may have been transformed.

At a next step 206, the compiler may perform another global CFG analysis to update the SSA graph by linking each of the new phi instructions to a definition of variable and a set of use reference. As discussed herein, use reference refers to how a definition of variable may be employed in an SSA graph. Since a definition of variable may be employed in multiple usages, a definition of variable may have a set of use references. To perform this link, the compiler may traverse the new dominator tree to determine the reaching definition for each of the use reference. In other words, the compiler may be discovering the originating basic block for the variable employed in a use reference. If the reaching definition is one of the new phi instructions, then the new phi instruction that has been reached may be added to the set of use references that the compiler may have to analyze. The compiler may continue analyzing each of the use references until no additional use reference is available for analysis.

Even if the compiler only analyze those use references that may be associated with a set of definitions of variables that may have been cloned, at a next step 208, the compiler may still have to perform another global CFG analysis to perform dead code elimination. In performing dead code elimination, phi instructions that may have been created during next step 204 and may not have been linked to any definition of variable and use reference in next step 206 may be removed.

There are several disadvantages with the prior art. For example, more than one global CFG analysis may have to be performed to update an SSA graph. Each global CFG analysis can expensive, especially when the CFG is an immediate representation of a module that may include thousands of lines of code. Thus, the process of updating a SSA graph each time a transformation may occur can become unnecessarily expensive as resources and time may be allocated to the process of analyzing basic blocks that may have not been impacted during a code transformation.

### SUMMARY OF INVENTION

The invention relates, in an embodiment, to a computer-implemented method for performing code optimization on source code. The computer-implemented method includes generating a first control flow graph and a first single static assignment graph from the source code. The computer-implemented method also includes generating a first dominator tree from the first flow control graph. The computer-implemented method further includes performing at least one of single static assignment-based high level optimization and code transformation utilizing at least one of the first flow control graph and the first single static assignment graph. The computer-implemented method moreover includes generating a second flow control graph responsive to the performing the code transformation. The computer-implemented method yet also includes generating a second single static assignment graph utilizing the second flow control graph and the first dominator tree. The computer-implemented method yet further includes generating optimized code utilizing the second flow control graph and the second single static assignment graph.

In another embodiment, the invention relates to an article of manufacture comprising a program storage medium having computer readable code embodied therein, the computer readable code being configured to perform code optimization on source code. The article of manufacture includes computer readable code for generating a first control flow graph and a first single static assignment graph from the source code. The article of manufacture also includes computer readable code for generating a first dominator tree from the first flow control graph. The article of manufacture further includes computer readable code for performing at least one of single static assignment-based high level optimization and code transformation utilizing at least one of the first flow control graph and the first single static assignment graph. The article of manufacture moreover includes computer readable code for generating a second flow control graph responsive to the performing the code transformation. The article of manufacture yet also includes computer readable code for generating a second single static assignment graph utilizing the second flow control graph and the first dominator tree. The article of manufacture yet further includes computer readable code for generating optimized code utilizing the second flow control graph and the second single static assignment graph.

In yet another embodiment, the invention relates to a computer-implemented method for performing code optimization on source code. The computer-implemented method includes providing a first control flow graph and a first single static assignment graph from the source code, and a first dominator tree associated with the first control flow graph. The computer-implemented method also includes performing single static assignment-based high level optimization on at least one of the first flow control graph and the first single static assignment graph. The computer-implemented method further includes performing code transformation utilizing the at least one of the first flow control graph and the first single static assignment graph. The computer-implemented method moreover includes generating a second flow control graph responsive to the performing the code transformation. The computer-implemented method yet also includes generating a second single static assignment graph utilizing the second flow control graph and the first dominator tree. The computer-implemented method yet further includes generating optimized code utilizing the second flow control graph and the second single static assignment graph.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a simple control flow graph (CFG) in a SSA form.

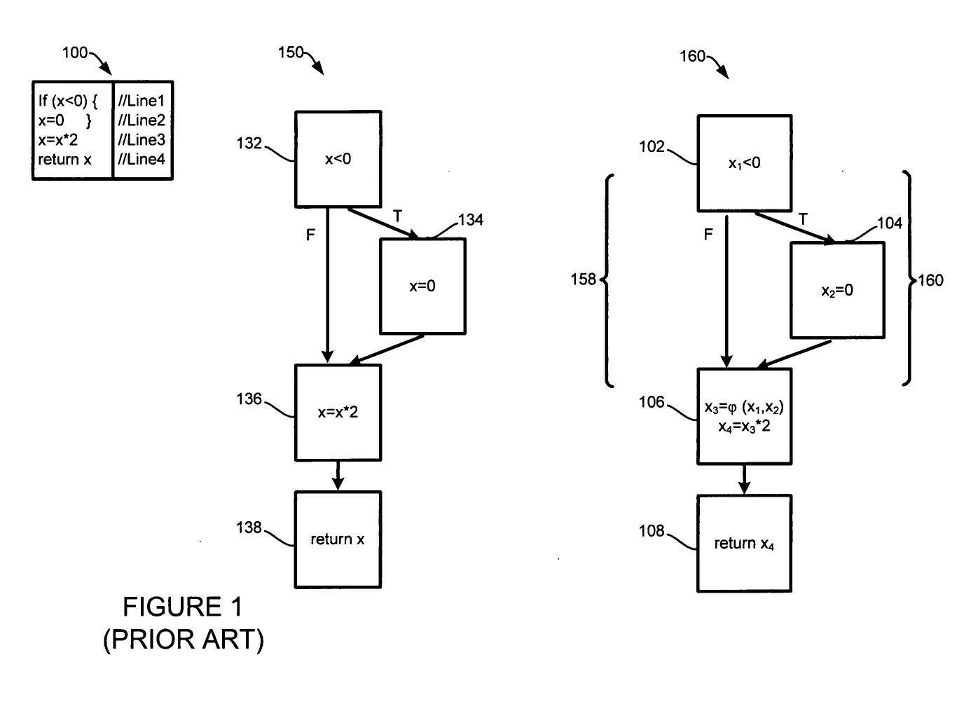

FIG. 2 shows a simple flow chart diagramming the steps for updating a SSA graph.

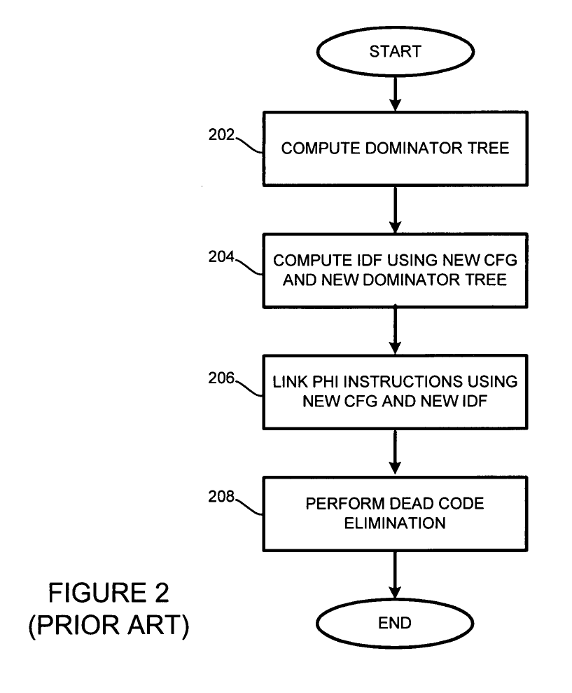

FIG. 3 shows, in an embodiment, the steps a compiler may perform to update a SSA graph after a code transformation.

FIG. 4 shows a source code with a combined CFG/SSA graph prior to a code transformation.

FIG. 5 shows a simple CFG after a code transformation has been performed.

FIG. 6 shows, in an embodiment, a CFG in combination with an updated SSA graph.

FIG. 7 shows, in an embodiment, a simple algorithm of a localized incremental SSA update for a region cloning transformation.

FIG. 8 shows a prior art example of a CFG/SSA graph.

### DETAILED DESCRIPTION OF VARIOUS EMBODIMENTS

The present invention will now be described in detail with reference to various embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover an article of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable circuits adapted for the various operations pertaining to embodiments of the invention.

In accordance with embodiments of the present invention, there is provided a method for performing localized incremental single static assignment (SSA) updates for a region cloning transformation. Embodiments of the invention include generating a new SSA by computing a set of new phi instructions for a set of iterative dominator frontier basic blocks for the cloned region. Further, embodiments of the invention also include linking each new phi instruction to a definition of variable and its set of use references.

Consider the situation wherein, for example, a compiler may have performed a code transformation, such as a tail duplication, on a region (i.e., set of basic blocks). In this document, various implementations may be discussed using tail duplication. This invention, however, is not limited to tail duplication and may be employed with any code transformation technique (e.g., loop unrolling).

Once the code transformation has occurred and the new control flow graph may have been generated, the current SSA graph may also have to be updated to reflect the set of new definitions of variables that may have been created from the set of new basic blocks.

In the prior art, the compiler may perform a global control flow graph analysis to determine a set of iterative dominator frontier basic blocks and to create new phi instructions. Also, the compiler may have to perform another global control flow analysis to link each of the new phi instructions to a definition of variable and its set of use references.

Unlike the prior art, localized incremental single static assignment (SSA) updates may be performed on a cloned region instead of on a complete control flow graph. In an embodiment, the compiler may identify the set of definitions that may have been cloned during the code transformation. For each definition that has been cloned, the compiler may identify a set of use references. For each use references, the compiler may traverse backward on a dominator tree, starting from a use reference basic block to identify the set of basic blocks that may need one or more new phi instructions (i.e., set of IDF basic blocks).

In an embodiment, the algorithm for performing localized incremental single static assignment (SSA) updates may be implemented by utilizing the original dominator tree generated prior to a code transformation. By not requiring a new dominator tree to be generated, the algorithm may be much simpler and may be easier and less expensive to implement. In addition, the inventive algorithm does not require that a set of IDF basic blocks and the new phi instructions be calculated separately from the linking step. Real-life implementations have shown that on average, 60% of the total time taken to perform code transformation and to update an SSA graph, in the prior art, may have been spent computing a set of IDF basic blocks for the complete CFG. Thus, by localizing the IDF analysis to the cloned region and by combining the IDF analysis with the linking step, a significant amount of time and resources may be saved.

In an embodiment, a basic block may receive a new phi instruction if the basic block's immediate dominator is an element of the cloned region. As discussed herein, an immediate dominator refers to a basic block which may directly dominate a second basic block. However, the immediate dominator may not be the only basic block dominating the second basic block. If the basic block's immediate dominator is not an element of the cloned region, then the compiler may continue to traverse backward on the dominator tree to analyze each of the basic blocks until an IDF basic block has been identified.

If the basic block is an IDF basic block, then the compiler may first verify that a new phi instruction for the definition of variable has not already been inserted. If no new inserted phi instruction has been created, then the compiler may insert a new phi instruction and may link the new instruction to the use reference being analyzed by updating the value of the use reference. However, if a new phi instruction has already been inserted, then the compiler may bypass the step of inserting a new phi instruction and may proceed to link the phi instruction to the use reference being analyzed.

Next, the compiler may make a determination on whether the IDF basic block is an exit point for the cloned region. As discussed herein, an exit point refers to a basic block outside the cloned region that may be connected via directed edges to cloned region's basic blocks. If the IDF basic block is not an exit point, then the new phi instruction that has just been updated may be added to the list of use references for the definition of variable that is currently being analyzed. In other words, the compiler may have to perform additional analysis on the new phi instructions.

If the IDF basic block is an exit point then the compiler may link the new phi instruction to the definition of original SSA variable being analyzed and each of the original SSA variable's clones. The compiler may continue an iterative process of analyzing each use reference for each definition of variable that has been cloned. Once each definition of variable has been analyzed, a new SSA graph may be generated. Unlike the prior art, no additional dead code elimination step may be required to remove extraneous new phi instructions (i.e., phi instructions that may have been created but have never been linked). By removing this step, additional time and resources may be saved.

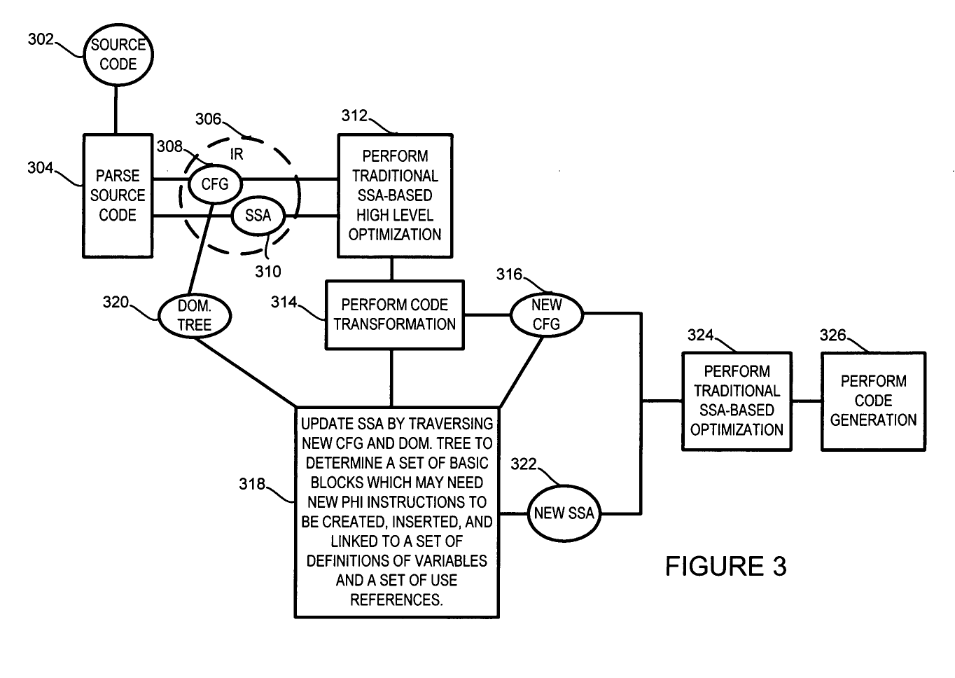

The features and advantages of the invention may be better understood with reference to the figures and discussions that follow. FIG. 3 shows, in an embodiment, the steps a compiler may perform to update a SSA graph after a code transformation. Consider the situation wherein, a computer program source code for a module is being analyzed by a compiler. At a first step 304, the compiler may parse a source code 302. In parsing source code 302, the compiler may transform source code 302 into a set of immediate representations 306, such as a CFG 308 and a SSA graph 310, which may be employed for code optimization and data flow analysis.

At a next step 312, the compiler may perform traditional SSA-based high-level optimization (e.g., global value numbering, conditional constant propagation, front-end loop optimization, etc.). The type of optimization that may be performed during this step generally tends to reduce redundant code or remove dead code (i.e., code that is never executed).

At a next step 314, source code 302 may be further optimized by code transformation. As discussed herein, code transformation refers to a technique of optimizing the source code by cloning a region (i.e., one or more basic blocks) of a CFG. Generally, the region that may be cloned may include a loop and/or require a set of instructions prior to a merge point to be completed before the rest of the instructions may be performed. Code transformation may include, but is not limited to, loop unrolling and tail duplication.

After code transformation has occurred, new basic blocks may have been added to the code and a new CFG 316 may be generated. Consequently, new CFG 316 may require an updated SSA graph to reflect the new definitions of variables that may have been created from the new basic blocks. At a next step 318, a new SSA graph 322 may be generated to reflect the changes. In an embodiment, the SSA graph may be updated by having the compiler traverses new CFG 316 in conjunction with a dominator tree 320 to identify the set of basic blocks (i.e., one or more basic blocks) that may need new phi instructions inserted.

Unlike the prior art, in computing new SSA graph 322, the compiler may traverse dominator tree 320, which may have been generated from original CFG 308. As discussed herein, a dominator tree refers to a tree that shows dominance relationships between basic blocks in a CFG. In an embodiment, the algorithm for performing localized, incremental SSA updates may not require an additional algorithm to generate a new dominator tree. By removing the necessity for a new dominator tree, the algorithm may be less expensive and may be easier to implement.

Also, unlike the prior art, localized incremental single static assignment (SSA) updates may be performed on a cloned region and the code surrounding the cloned region instead of on the complete CFG. In traversing the dominator tree, the use references for each of the definition of variable that may have been cloned may be analyzed. In an embodiment, the compiler may traverse incrementally backward from a use reference basic block up the dominator tree to identify the set of basic blocks that may need one or more new phi instructions (i.e., set of IDF basic blocks).

In an embodiment, once an IDF basic block has received a new phi instruction, the compiler may then link the new phi instruction to the use reference being analyzed and ultimately to the definition of variable associated with the use reference. The algorithm may be iteratively performed until each use reference for each definition of variable that may have been cloned have been analyzed and linked. Once each definition of variable has been analyzed, a new SSA graph 322 may be generated.

With the addition of new basic blocks, at a next step 324, the compiler may perform more traditional SSA-based optimization to reduce redundant code or remove dead code. At a next step 326, code generation may occur with an executable file as the final result.

FIG. 3 is not meant to show all the steps that may occur while a module is being compiled. Instead, FIG. 3 is meant to illustrate at which point an SSA graph may have to be updated. Since those who are skilled in the arts understand the different steps that a compiler may perform, no further discussion will be provided about features of the compiler that do not relate to how an SSA graph may be updated.

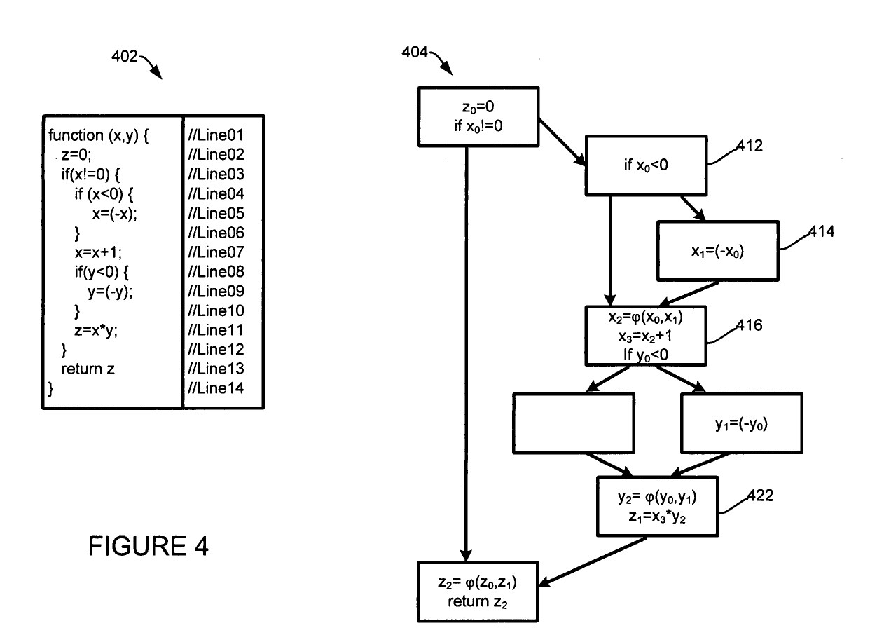

FIG. 4 provides further details on the algorithm for performing localized, incremental SSA updates on a cloned region. FIG. 4 shows a source code 402 with a combined CFG/SSA graph 404 prior to a code transformation. Consider the situation wherein, for example, a compiler performs a code transformation, such as a tail duplication, to basic block 416 of CFG/SSA graph 404. In tail duplication, the basic block which may be cloned is a basic block from which two or more other basic blocks may have to flow through to traverse to another basic block. In an example, both basic blocks 412 and 414 have to traverse through basic block 416 to reach basic block 422. Since basic block 422 may not be reached until both basic blocks 412 and 414 have each returned a value to basic block 416, the source code may be optimized by cloning basic block 416 to remove the interdependence between basic blocks 412 and 414.

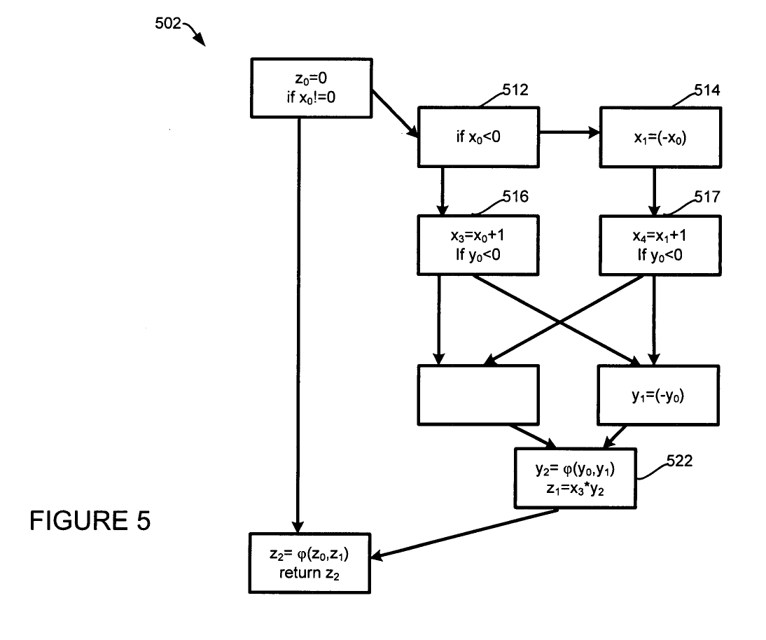

FIG. 5 shows a simple CFG 502 for source code 402 after a code transformation (i.e., tail duplication) has been performed. During the tail duplication process, basic block 516 may have been duplicated to create a cloned basic block 517, which may have the same instruction as basic block 516. As can be seen in CFG 502, a directed edge flow between basic block 512 and basic block 516 while another directed edge flow between basic block 514 and cloned basic block 517. In other words, basic block 512 may now traverse to basic block 516 without having to wait for basic block 514 to be completed. Similarly, basic block 514 may now traverse to basic block 517 without having to wait on basic block 512. As also can be seen, since basic block 516, and likewise cloned basic block 517, is no longer receiving values from multiple sources, the phi instruction ‘x₂=φ(x₀,x₁)’ is no longer valid and has been removed and is no longer part of basic block 516 or its clone.

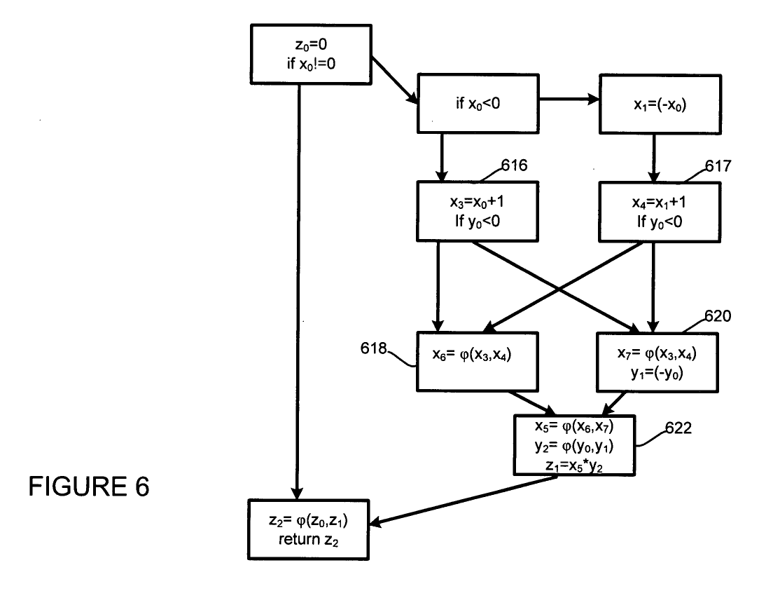

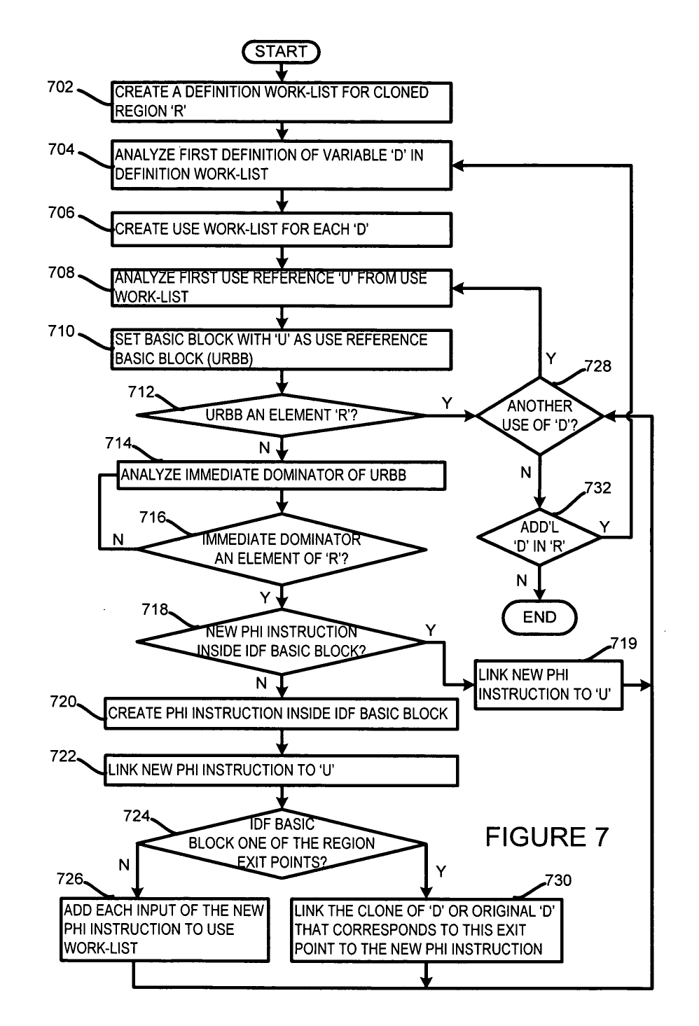

As aforementioned, a code transformation generally results in at least one additional basic block being added to the CFG. With a new CFG generated, a new SSA graph may also have to be created to reflect the changes in the CFG. FIG. 6 shows, in an embodiment, a CFG in combination with an updated SSA graph. FIG. 7 will be use to explain how FIG. 6 may have been generated.

FIG. 7 shows, in an embodiment, a simple algorithm of a localized incremental SSA update for a region cloning transformation. At a first step 702, a definition work-list may be created. The definition work-list may include definitions of variables from the original SSA graph that may exist in the cloned region. Referring back to FIG. 5, ‘x₃=x₀+1 in basic block 516 is the definition that has been cloned. Referring back to FIG. 7, at a next step 704, the compiler may remove the first definition of variable from the definition work-list to analyze.

At a next step 706, the compiler may create an initial use work-list for the definition of variable being analyzed. As the compiler analyzes the definitions, the use work-list may grow as new phi instructions may be inserted as new use for each of the definitions being analyzed from the definition work-list, in an embodiment. Referring back to FIG. 5, ‘z₁=x₃*y₂’ of basic block 522 is an example of a use reference that may be added to the use work-list. At this point in the example, the initial use work-list has no other use references. Referring back to FIG. 7, at a next step 708, the compiler may remove the first use reference from the use work-list to analyze.

With each use reference, the compiler may traverse backward on the original dominator tree to determine which immediate basic block may require a new phi instruction to be inserted, in an embodiment. At a next step 710, the basic block that holds the use reference being analyzed is designated as a use reference basic block. Referring to FIG. 5, basic block 522 is designated as the use reference basic block since basic block 522 includes the use reference (i.e., ‘z₁=x₃*y₂’) that is being analyzed. As discussed herein, use reference basic block refers to the basic block being analyzed by a compiler.

At a next step 712, in an embodiment, the compiler may make a determination on whether or not the use reference basic block is an element of the cloned region. If the use reference basic block is an element of the cloned region, then no new phi instruction has to be created or inserted, in an embodiment. No new phi instruction may be needed if the use reference is within the same block as the cloned definition of variable.

However, if the use reference basic block is not an element of the cloned region, then the compiler may analyze the immediate dominator of the use reference basic block at a next step 714, in an embodiment. In an embodiment, the immediate dominator that is being considered may be part of the original dominator tree. In an example, basic block 522 is not part of the region that has been cloned. As a result, the immediate dominator for basic block 522, which is basic block 516, is analyzed next by the compiler.

At a next step 716, the compiler may analyze the immediate dominator (e.g., basic block 516) to determine if the immediate dominator is an element of the cloned region. If the immediate dominator is not an element of the cloned region, then the compiler may return to next step 714 to analyze the next basic block up the dominator tree. Steps 714 and 716 may be repeated, in an embodiment, until a basic block has been identified as an element of the cloned region.

In an embodiment, if the basic block being analyzed is an element of the cloned region, then the previous analyzed basic block is an IDF basic block. In other words, a new phi instruction may need to be inserted. Referring to FIG. 5, basic block 516 is within the cloned region and is therefore an element of the cloned region. Since basic block 516 is an immediate dominator of basic block 522, basic block 522 is therefore an IDF basic block and may need a new phi instruction to be inserted.

At a next step 718, the compiler may make a determination on whether or not a new phi instruction has been inserted into the IDF basic block yet, in an embodiment. If a new phi instruction has not been added to the IDF basis block, then the compiler may create a new phi instruction inside the IDF basic block, at a next step 720. Referring to FIG. 6, a new phi instruction (‘X₅=φ(unknown variable1, unknown variable2)’) has been created for basic block 622. Although the new phi instruction may be created the values for the unknown variable1 and unknown variable2 may still be unknown. At a next step 722, the new phi instruction may be link to the use reference, in an embodiment. In other words, since a new phi instruction has been created, the use reference being analyzed may also be updated to reflect the changes to the value of the use reference. Referring to FIGS. 5 and 6, the variable ‘x’ in the use reference ‘z₁=x₃*y₂’ in basic block 522 of FIG. 5 may now be updated to reflect that the value is now coming from x₅ and not from x₃. As a result, the use reference ‘z₁=x₃*y₂’ in basic block 522 of FIG. 5 has now been updated to become ‘z₁=x₅*y₂’ in basic block 622 of FIG. 6.

At a next step 724, the compiler may determine whether or not the IDF basic block is one of the region exit points, in an embodiment. As discussed herein, an exit point refers to a basic block that is outside of a cloned region but may be connected to one or more basic blocks from within the cloned region. Referring to FIG. 6, only basic blocks 618 and 620 are exit points of the cloned region. As a result, basic block 622 is not an exit point and the new phi instruction ‘x₅=φ(unknown variable1, unknown variable2)’ may be added to the current use work-list as a use reference for the current cloned definition, at a next step 726. In an embodiment, the number of time a new phi instruction may be added may be based on the number of variables that may be included in a phi instruction. Referring to FIG. 6, the new phi instruction ‘x₅=φ(unknown variable1, unknown variable2)’ includes two variables (i.e., unknown variable1 and unknown variable2).

If at next step 718, a new phi instruction has already been inserted into the IDF basic block, then the compiler may proceed to a next step 719 to link the phi instruction to the use reference, in an embodiment. Similar to step 722, the use reference being analyzed may also be updated to reflect the changes to the value of the use reference. Since the phi instruction has already been analyzed previously, the phi instruction may already be connected to a definition of variable and next steps 724 and 726 may be bypassed.

At a next step 728, the compiler may check the use work-list to determine if another use reference exists for the current cloned definition. If another use reference exists, then the compiler may return to next step 708 to analyze the next use reference. In this example, another two use references may still exist in the use reference work-list.

Steps 706 through steps 728 may be repeated until all use references in the use work-list have been analyzed. In an example, ‘unknown variable1 of use reference ‘x₅=φ(unknown variable1, unknown variable2)’ may be analyzed next. Unlike other use references, the basic block that may be associated with a new phi instruction use reference is not the basic block that holds the phi instruction. Instead, the basic block that may be analyzed is the basic block that derives the value, in an embodiment. Referring to FIG. 6, the compiler may be able to determine that the value for unknown variable1 may flow from basic block 618 and the value for unknown variable2 may flow from basic block 620.

Since the compiler has identified that the value for unknown variable1 may flow from basic block 618, basic block 618 may now be designated as a use reference basic block. Basic block 618 may be analyzed to determine if basic block 618 may be an element of the cloned region. Since basic block 618 is not an element of the cloned region, then the immediate dominator of basic block 618, which is basic block 616, is analyzed next.

The compiler may next make a determination on whether or not the immediate dominator (i.e., basic block 616) is an element of the cloned region. Since basic block 616 may be an element of the cloned region, then basic block 618 may be an IDF basic block. The compiler may first analyze basic block 618 to determine if a new phi instruction has already been added to the IDF basic block. Since basic block 618 does not currently have a new phi instruction, a new phi instruction ‘x₆=φ(unknown variable3, unknown variable4)’ may be created and added into basic block 618.

After the new phi instruction has been added, the new phi instruction may be linked to the use reference. In this example, since unknown variable1 of use reference equation ‘x₅=φ(unknown variable1, unknown variable2)’ of basic block 622 is being analyzed, the new phi instruction in basic block 618 is linked to unknown variable1 of basic block 622 and the use reference equation ‘x₅=φ(unknown variable1, unknown variable2)’ may be updated to become ‘x₅=φ(x₆, unknown variable2)’.

After linking the new phi instruction to the use reference, the compiler may then determine if the use reference basic block (i.e., basic block 618) is an exit point. Since basic block 618 has a directed edge flowing from the cloned region, basic block 618 may be designated as an exit point. The compiler may then, at a next step 730, link the definition being analyzed to the new phi instruction. Since the use reference basic block is also an exit point, the compiler may, in an embodiment, update the unknown variables in the new phi instructions with definitions from the cloned region. Referring to FIG. 6, new phi instruction ‘x₆=φ(unknown variable3, unknown variable4)’ may be updated to reflect that the unknown variable3 and the unknown variable4 may flow from x₃ of basic block 616 and x₄ of basic block 617, accordingly. Once linked, the new phi instruction basic block 618 may be updated from ‘x₆=φ(unknown variable3, unknown variable4)’ to ‘x₆=φ(x₃, x₄)’.

The compiler may continue to iteratively perform steps 708 through steps 730 until the use work-list is empty, in an embodiment. Once empty, at a next step 732, the compiler may check the definition work-list to determine if another definition may need to be analyzed. Step 704 through step 732 may be iterative until the definition work-list is empty, in an embodiment. If no additional cloned definition exists, then the compiler has completed updating and generating a new SSA graph. In an embodiment, if more than one region has been cloned, than each region may be analyzed accordingly.

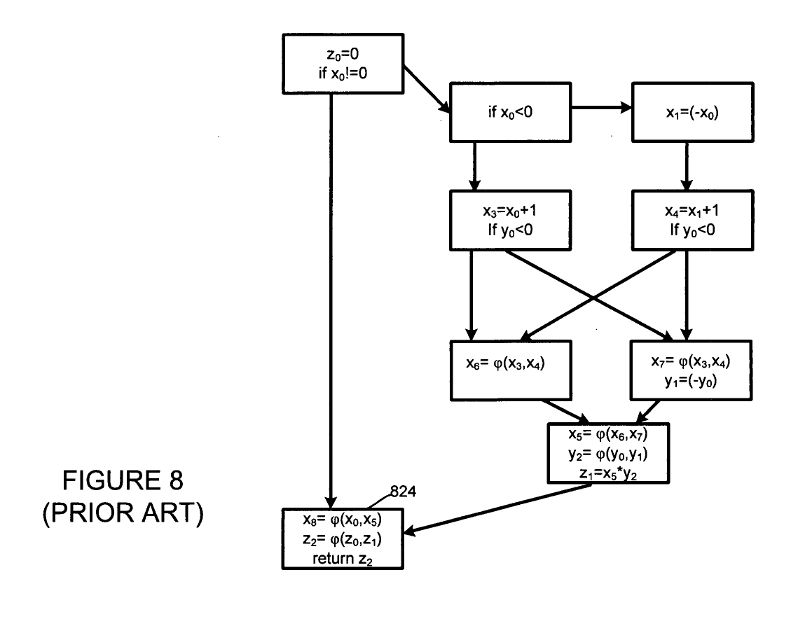

Since the algorithm of FIG. 7 may be locally applied to a cloned region without having to create extraneous phi instructions, no dead phi instructions may be generated. Unlike the prior art, the compiler does not have to spend additional time and resources to perform an additional global CFG analysis to remove superfluous phi instructions. See FIG. 8 for a prior art example of a dead phi instruction that have been created in generating a CFG/SSA graph for source code 402. As can be seen, basic block 824 include an extraneous phi instruction ‘x₈=φ(x₀, x₅)’ that may be created using the prior art method but is considered as a dead phi instruction since the phi instruction is not connected to a use reference.

As can be appreciated from embodiments of the invention, the method of performing localized, incremental SSA updates on a region cloning transformation provides a more efficient and effective method of generating a new SSA graph. Since the algorithm is performed locally, cloned region of large complex method may be analyzed without causing unnecessary constraint on the compiler resources. Further, this method is a simpler algorithm which may be easily implemented in existing compilers. Thus, a faster and simpler algorithm equates to a quicker turnaround in a dynamic compiler environment.

While this invention has been described in terms of several embodiments, there are alterations, permutations, and equivalents, which fall within the scope of this invention. Also, the title, summary, and abstract are provided herein for convenience and should not be used to construe the scope of the claims herein. Further, in this application, a set of “n” refers to one or more “n” in the set. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method for performing code optimization on source code, comprising:
generating a first control flow graph and a first single static assignment graph from said source code;
generating a first dominator tree from said first flow control graph;
performing at least one of single static assignment-based high level optimization and code transformation utilizing at least one of said first flow control graph and said first single static assignment graph;
generating a second flow control graph responsive to said performing said code transformation;
generating a second single static assignment graph utilizing said second flow control graph and said first dominator tree; and
generating optimized code utilizing said second flow control graph and said second single static assignment graph.

2. The computer-implemented method of claim 1 wherein said second single static assignment graph is generated by performing at least one localized incremental update on a cloned region of said second flow control graph.

3. The computer-implemented method of claim 2 wherein said cloned region is ascertained by identifying a set of definitions cloned during said code transformation.

4. The computer-implemented method of claim 3 wherein ascertaining said cloned region further including identifying a set of use references for said set of definitions.

5. The computer-implemented method of claim 4 wherein said ascertaining said cloned region further includes traversing backward on said first dominator tree starting from a user reference basic block to identify a set of basic blocks that require at least one new phi instruction.

6. The computer-implemented method of claim 2 wherein said code transformation includes tail duplication.

7. The computer-implemented method of claim 2 wherein said code transformation includes loop unrolling.

8. The computer-implemented method of claim 1 wherein said code optimization is performed using at least a compiler.

9. An article of manufacture comprising a program storage medium having computer readable code embodied therein, said computer readable code being configured to perform code optimization on source code, comprising:
computer readable code for generating a first control flow graph and a first single static assignment graph from said source code;
computer readable code for generating a first dominator tree from said first flow control graph;
computer readable code for performing at least one of single static assignment-based high level optimization and code transformation utilizing at least one of said first flow control graph and said first single static assignment graph;
computer readable code for generating a second flow control graph responsive to said performing said code transformation;
computer readable code for generating a second single static assignment graph utilizing said second flow control graph and said first dominator tree; and
computer readable code for generating optimized code utilizing said second flow control graph and said second single static assignment graph.

10. The article of manufacture of claim 9 wherein said second single static assignment graph is generated by performing at least one localized incremental update on a cloned region of said second flow control graph.

11. The article of manufacture of claim 10 wherein said cloned region is ascertained by identifying a set of definitions cloned during said code transformation.

12. The article of manufacture of claim 11 wherein ascertaining said cloned region further including identifying a set of use references for said set of definitions.

13. The article of manufacture of claim 12 wherein said ascertaining said cloned region further includes traversing backward on said first dominator tree starting from a user reference basic block to identify a set of basic blocks that require at least one new phi instruction.

14. The article of manufacture of claim 10 wherein said computer readable code for performing said code transformation includes computer readable code for performing loop unrolling.

15. The article of manufacture of claim 10 wherein said computer readable code for performing said code transformation includes computer readable code for performing tail duplication.

16. A computer-implemented method for performing code optimization on source code, comprising:
providing a first control flow graph and a first single static assignment graph from said source code, and a first dominator tree associated with said first control flow graph;
performing single static assignment-based high level optimization on at least one of said first flow control graph and said first single static assignment graph;
performing code transformation utilizing said at least one of said first flow control graph and said first single static assignment graph;
generating a second flow control graph responsive to said performing said code transformation;
generating a second single static assignment graph utilizing said second flow control graph and said first dominator tree; and
generating optimized code utilizing said second flow control graph and said second single static assignment graph.

17. The computer-implemented method of claim 16 wherein said second single static assignment graph is generated by performing at least one localized incremental update on a cloned region of said second flow control graph.

18. The computer-implemented method of claim 17 wherein said cloned region is ascertained by identifying a set of definitions cloned during said code transformation.

19. The computer-implemented method of claim 18 wherein ascertaining said cloned region further including identifying a set of use references for said set of definitions.

20. The computer-implemented method of claim 19 wherein said ascertaining said cloned region further includes traversing backward on said first dominator tree starting from a user reference basic block to identify a set of basic blocks that require at least one new phi instruction.
